(19) United States
(12) Patent Application Publication
(10) Pub. No.: US 2023/0018237 A1
(43) Pub. Date: Jan. 19, 2023

(54) MANUAL INSPECTION WORKSTATION

(71) Applicant: QUANTUM PACKAGING TECHNOLOGIES, INC., White Lake, MI (US)

(72) Inventor: G. Scott Smith, White Lake, MI (US)

(21) Appl. No.: 17/779,895

(22) PCT Filed: Nov. 25, 2020
(86) PCT No.: PCT/US2020/062160

§ 371 Date: May 25, 2022

Related U.S. Application Data
(60) Provisional application No. 62/940,670, filed on Nov. 26, 2019.

(51) Int. Cl. G01N 21/88; G01J 3/50

(52) U.S. Cl. CPC G01N 21/8806; G01J 3/50; G01N 21/8803; G01N 2021/8845

(57) ABSTRACT

A manual inspection workstation, including abase and a body pivotally connected to one another and moveable between an upright position and compacted stowed position. A hood is connected to the body opposite the base and at least partially houses a light source. The manual inspection workstation includes a surface coating with physical properties that meet and exceed various FDA and U.S. Pharmacopeia guidelines and requirements. The light source includes a plurality of lighting options including intensity, color output, hue, and saturation. The light source further includes a communications module that allows multiple light sources to be wired together In a sequence or ring. The communications module further includes wireless connectivity to a remote computing device. The light source may further include an internal microprocessor and memory for instituting certain preconfigured light profile protocols.

### CROSS-REFERENCE TO RELATED APPLICATION

This PCT international Patent Application claims the benefit of and priority to U.S. Provisional Patent Application Ser. No. 62/940,670 filed on Nov. 26, 2019, and titled “Manual Inspection Workstation,” the entire disclosure of which is hereby incorporated by reference.

### BACKGROUND OF THE INVENTION

### 1. Field of the Invention

The present invention relates a manual inspection workstation and a method of assembling same. More particularly, the present invention relates to a manual inspection workstation for use in a laboratory or manufacturing setting and a method of assembling same.

### 2. Related Art

This section provides background information related to the present disclosure which is not necessarily prior art.

Visual inspection is a process used in numerous industries to examine various structures by way of visual, auditory, tactile, olfactory, and other sensory behaviors. Visual inspection techniques have improved by leveraging advances in technology. For example, these numerous industries include quality control in manufacturing and laboratory settings, medical, pharmaceutical, research, and other industries. The medical and research industries have particularly benefited greatly from advances in technology. These advances in technology have coincided with more accurate and less invasive means of a diagnosis and treatment of medical ailments. Studies in the research or laboratory settings have also become more and more complex and accurate as a result of technology advancement. One area of technology that is of particular importance in the medical, pharmaceutical, and research industry (as well as other industries which utilize the visual inspection process) is imaging. Imaging technologies have allowed trained personnel to get a visualization of organic matter (e.g., particulate matter) that was previously challenging with the naked eye. More particularly, imaging technologies can visualize subsurface matter, flow paths, and microscopic objects. However, these visualizations are not intrinsically diagnostic, in other words, they still require a trained human eye to examine and ultimately interpret.

In many circumstances, biological matter or other non-biological structures can be visualized and interpreted by trained personal without the assistance of advanced imaging technology. For example, various studies have required progressing vials of chemical and biological matter or other non-biological structures through various processes and periodically reviewing the state. Likewise, many studies include periodically checking responses to mixing different types of elements. Other examples include visual inspection of IV bags, syringes, ampoules, and quality control inspection of other structures in other industries. To assist in the visual inspection, inspection stations are used that provide a source of light and a contrasting back plate. In use, the structure to be examined is placed on a work surface of the inspection station. Prior to human examination, an inspector may invert, swirl, or otherwise examine the structure for defects in front of a contrasting back plate and intensity from the source of light can be adjusted for maximizing observable features. Inspected structures must be free from visible particulates as when examined without magnification (except for optical correction as may be required to establish normal vision) against a black background and against a white background. While these inspection stations have provided significant improvements to visual inspection with the naked eye, they are large and cumbersome, expensive, and offer only limited settings to adjust the source of light.

The Food and Drug Administration (FDA), or any other food and drugs regulatory agency round the globe not only ask for a product that meets its specification but also require a process, procedures, intermediate stages of inspections, and testing adopted during manufacturing are designed such that when they are adopted they produce consistently similar, reproducible, desired results which meet the quality standard of product being manufactured and complies the Regulatory and Security Aspects. Such procedures are developed through the process of validation. This is to maintain and assure a higher degree of quality of food and drug products. “Process validation” is defined as the collection and evaluation of data, from the process design stage through commercial production, which establishes scientific evidence that a process is capable of consistently delivering quality product. Process validation involves a series of activities taking place over the lifecycle of the product and process. For example, process validation includes reviewing properties of the light source, such as lux and color.

Accordingly, there is a continuing desire to further develop and refine such stations such that they are more ergonomic, less cumbersome and provide additional and improved settings to the source of light and make the device easier to regulated and validated.

### SUMMARY OF THE INVENTION

This section provides a general summary of the disclosure and is not to be interpreted as a complete and comprehensive listing of all of the objects, aspects, features and advantages associated with the present disclosure.

According to one aspect of the disclosure, a manual inspection workstation is provided. The manual inspection workstation includes a base and a body pivotally connected to one another and moveable between an upright position and compacted stowed position. A hood is connected to the body opposite the base and at least partially houses a light source. The manual inspection workstation includes a surface coating with physical properties that meet various guidelines and requirements. The light source includes a plurality of lighting options including intensity, color output, hue, and saturation. The light source further includes a communications module that allows multiple light sources to be wired together in a sequence or ring. The communications module further includes wireless connectivity to a remote computing device. The light source may further include an internal microprocessor and memory for instituting certain preconfigured light profile protocols.

In accordance with another aspect of the disclosure, a light source circuit is provided that includes a RGB circuit, a microcontroller, microprocessor, and memory. Software and profile settings are saved on the memory and translated into light output by the microprocessor. A communications module connects the associated light source with other light sources and remote computing devices.

In accordance with yet another aspect, a manual inspection workstation is provided. The manual workstation assembly comprises a base for placement of an inspected element and a body pivotally connected to the base and movable between an upright position and a stowed position. A hood is located on the body opposite the base and at least one light source is located within the hood.

In accordance with another aspect, a manual inspection workstation is provided. The manual inspection workstation comprises a base for placement of an inspected element and a body connected to the base. At least one light source located on the body. The manual inspection workstation comprises a light source circuit. The light source circuit comprises a processor and a memory that includes instructions that, when executed by the processor, cause the processor to change at least one setting on the at least one light source. The at least one setting includes one or more of a light intensity, a color temperature, a saturation, or a hue.

Further areas of applicability will become apparent from the description provided herein. As understood, the description and specific example of various embodiments listed, in this summary are only intended to illustrate some of the inventive concepts and are not intended to limit the full and fair scope of protection afforded to the present disclosure.

### BRIEF DESCRIPTION OF THE DRAWINGS

The drawings described herein are for illustrative purposes only of selected embodiments and are not intended to limit the scope of the present disclosure. The incentive concepts associated with the present disclosure will be more readily understood by reference to the following description in combination with the accompanying drawings wherein:

FIG. 1A is a perspective view of a manual inspection workstation assembly in accordance with a first embodiment of the disclosure;

FIG. 1B is a side view of the manual inspection workstation assembly;

FIG. 2A is a perspective view of the manual inspection workstation in a stowed position;

FIG. 2B is a side view of the manual inspection workstation in a stowed position;

FIG. 3A is a front view of the manual inspection workstation assembly;

FIG. 3B is a top view of the manual inspection workstation assembly;

FIG. 4A is a perspective view of a manual inspection workstation assembly in an upright position in accordance with a second embodiment of the disclosure;

FIG. 4B is a perspective view of the manual inspection workstation assembly from FIG. 4A in a stowed position;

FIG. 5 is a perspective view of a manual inspection workstation assembly in accordance with a third embodiment of the disclosure;

FIG. 6A is a front view of a light source used in conjunction with the manual inspection workstation;

FIG. 6B is a left-side view of the light source used in conjunction with the manual inspection workstation;

FIGS. 6C is a right-side view of the light source used in conjunction with the manual inspection workstation;

FIGS. 6D is an enlarged view of a user interface of the light source used in conjunction with the manual inspection workstation;

FIG. 7 is a schematic view of a light source circuit and a connected remote computing device;

FIG. 8A is a schematic view of a series of light sources in communication with one another;

FIG. 8B is a schematic view of a series of light sources in a modified arrangement, wherein each of the light sources are connected to a remote computing device; and

FIG. 9 is a method flow chart illustrating a process of constructing the manual inspection workstation assembly.

### DESCRIPTION OF THE ENABLING EMBODIMENT

Example embodiments will now be described more fully with reference to the accompanying drawings, In general, the subject embodiments are directed to a manual inspection workstation, or inspection station, and a method of assembling same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the manual inspection workstation is intended for providing a strong and relatively lightweight design that is portable and offers a plurality of light settings to maximize visualization of the examined matter, such as particulate matter, cosmetic defects in parenteral drugs or associated medical devices (syringes, labels, etc.). However, unless otherwise indicated it should be appreciated that the manual inspection workstation can be utilized in any industry wherein visual inspection is utilized.

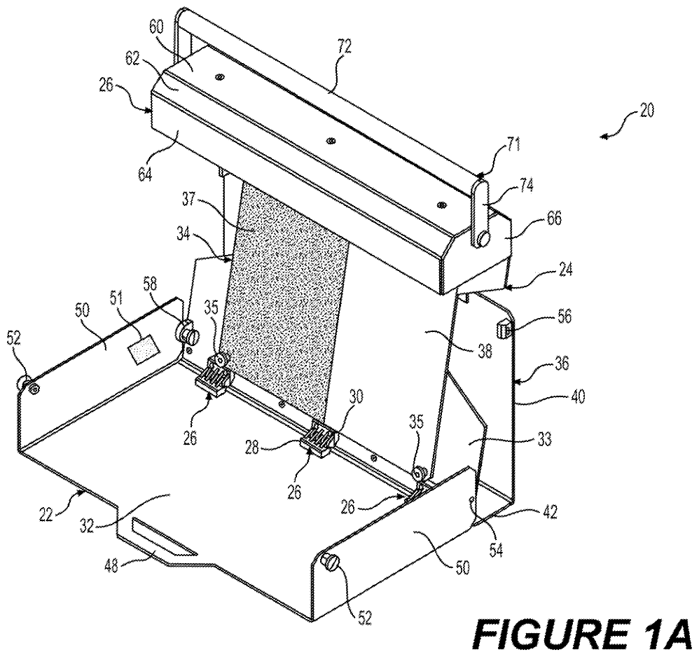

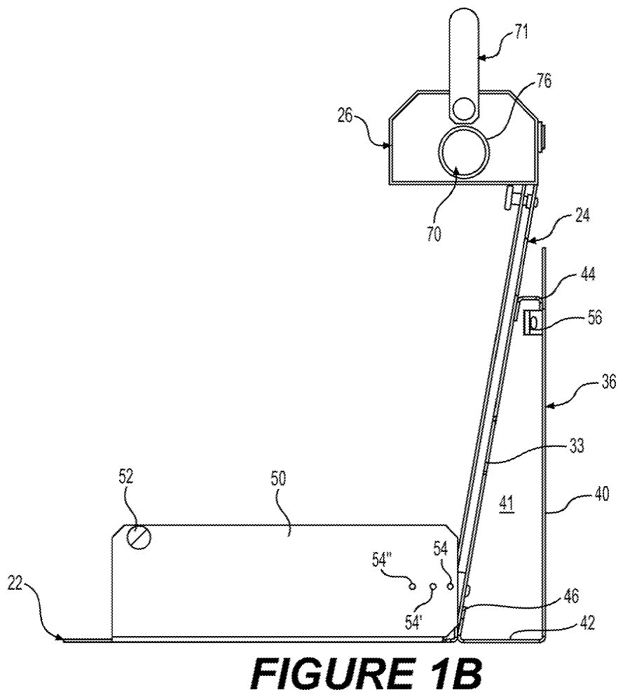

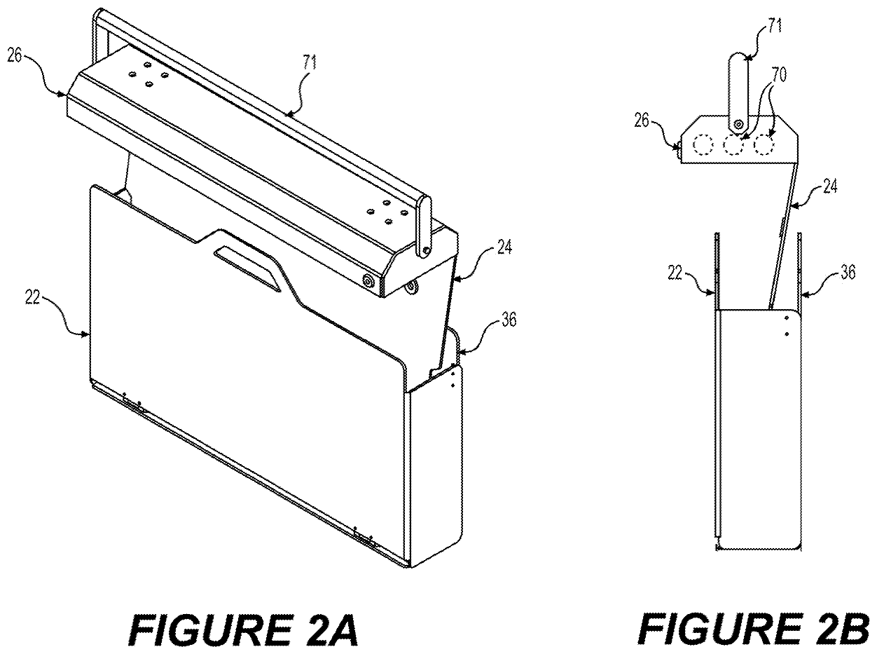

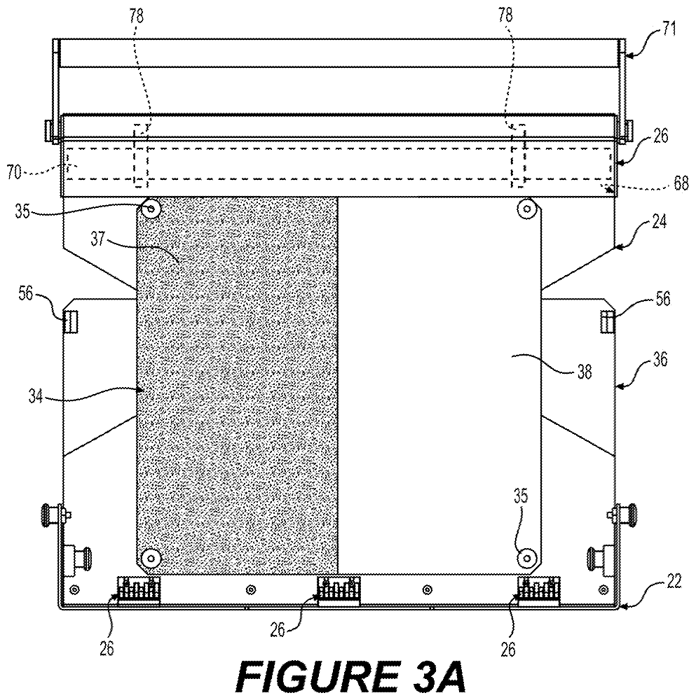

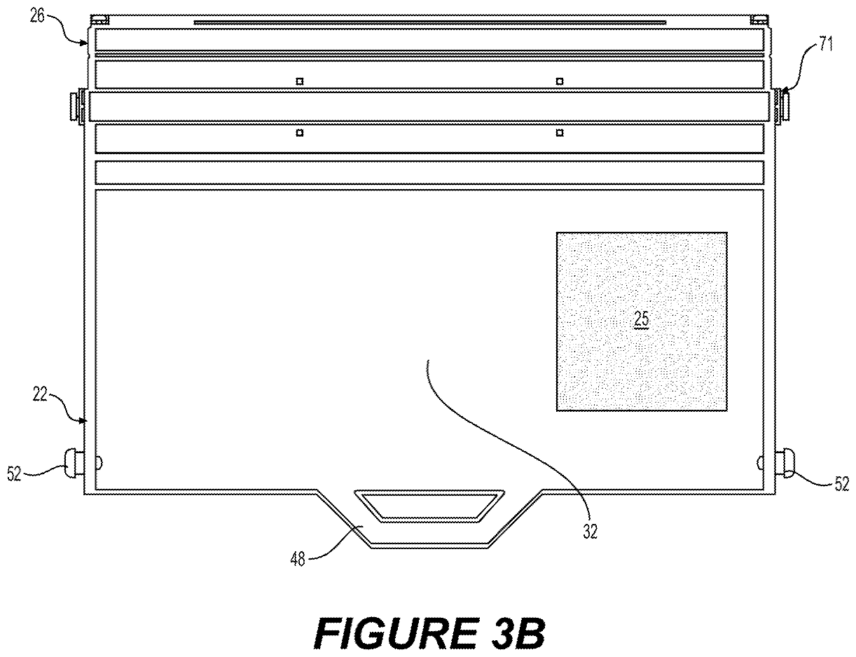

Referring initially to FIG. 1A, the manual inspection workstation assembly 20 is shown from a perspective orientation. The manual inspection workstation 20 includes a base 22 for positioning on a tabletop or other working surface and a body 24 that extends vertically front the base 22 to a hood 26. The body 24 pivotally connects to the base 22 with at least one hinge 26, which may include three hinges 26. Each hinge 26 includes a first knuckle portion 28 connected to the base 22 and a second knuckle portion 30 connected to the body 24 that are interlaced and held together with a pin (not shown). As such, pivoting movement of the body 24 with respect to the base 22 is permitted between an upright position (FIGS. 1A and 1B) and a stowed position (FIGS. 2A and 2B). As will be described in further detail below, all or select portions of the manual inspection workstation assembly 20 may include at least one coating 25 of protective material (FIG. 3B).

The base 22 includes a work surface 32 to place the matter that is to be observed. The body 24 includes a back plate 33 that extends between the second knuckle portion 30 and the hood 26. A contrast plate 34 is connected to the back plate 33 with fasteners 35 and includes a white surface 37 and a black surface 38 for contrasting the matter that is to be observed. The body 24 further includes a support bracket 36 that connects to the back plate 33 and holds the body 24 in the upright position. As best shown in FIG. 1B, the bracket 36 has an L-shape configuration that includes a vertical plate 40 and a horizontal plate 42. A pocket 41 is located between the vertical plate 40, the horizontal plate 42, and the back plate 33 and can be used to store items such as files, power chords, or matter to be observed. A top portion of the vertical plate 40 includes an upper prop member 44 and the horizontal plate 42 extends from a bottom portion of the vertical plate 40 to a lower prop member 46. Both prop members 44, 46 may connect the bracket 36 to the back plate 33 such that pivoting movement of the back plate 33 effectuates the same movement of the bracket 36. In some arrangements, one or more of the prop members 44, 46 may be moveable and/or adjustable to change the angle between the body 24 and the base 22 in the upright position. The base portion 22 is generally rectangular-shaped, wherein one of the edges connects to the at least one hinge 26 and an opposite edge includes a base handle 48. A pair of sidewalls 50 extend vertically along opposite edges between the edge with the base handle 48 and the edge with at least one hinge 26. The sidewalk 50 each include a stowed fastener 52 adjacent to the edge with the base handle 48 and an upright aperture 54 adjacent to the edge with the at least one binge 26. The bracket 36 includes a pair catches 56 spaced for receiving the stowed fasteners 52 when the body 24 is in the stowed position. The back plate 33 includes upright fasteners 58 spaced for engagement with the upright apertures 54 on the sidewalls 50, when the body 24 is in the upright position. As shown in FIG. 1B, there may be a series of upright apertures 54, 54′, 54| to change the angle between the body 24 and the base 22 in the upright position.

The hood 26 includes a top surface 60 with chamfered edges 62 and elongated sidewalls 64 extending along the chamfered edges between a pair of end sidewalls 66. The top surface 60, elongated sidewalls 64, and the end sidewalls 66 define a light chamber 68. At least one light source 70 is located within the light chamber 68 and light projecting therefrom is at least partially guided by the sidewalls 64, 66 towards the work surface 32. The at least one light source 70 may include one, two, three, four, five, or more light sources 70. If more than one light source 70 is utilized, they are preferably arranged in a parallel relationship as indicated by the dotted lines in FIG. 2B. The hood 26 further includes a handle 71 extending between opposite end sidewalls 66 and includes a shaft portion 72 and a pair of tabs 74. Each of the tabs 74 extends between a first end and a second end. The first end of each tab 74 is pivotally connected to the end sidewalls 66 and the second end is attached to the shaft portion 72. The shaft portion 72 extends between tabs 74 along an axis and may be allowed to rotate with respect to the tabs 74 along the axis. As best shown in FIG. 1B, one or both of the end sidewalls 66 may include an insertion hole 76 for placement of the light source 70. Light support brackets 78 (FIG. 3A), may be located within the light chamber 68 for supporting the light source 70 once inserted. As illustrated in FIG. 1A, a photometric sensor 51 may be included to log information regarding the light output from the light source 70.

FIGS. 2A and 2B illustrate the manual inspection workstation assembly 20 in the stowed position, wherein it can be carried around by holding the handle 71. In the stowed position, the manual inspection workstation assembly 20 has a compact design and is shaped similar to a closed brief case such that it can be easily moved between locations and stored. The pocket 41 is completely or substantially enclosed when in the stowed position. The manual inspection workstation assembly 20 can be balanced and stored on the horizontal plate 42.

FIGS. 3A and 3B provide alternative orientational views of the manual inspection workstation assembly 20. FIG. 3A is a front view of the manual inspection workstation assembly 20 in an upright position illustrating the light source 70 in phantom lines located behind the elongated sidewall 64 and held in place with the light support brackets 78, which are also presented in phantom lines behind the elongated sidewall 64. The light support brackets 78 may be annularly shaped and cradle the light source 70 when inserted therein and spaced substantially an entire length of the light source 70. FIG. 3B is a top view of the manual inspection workstation assembly 20 in an upright position illustrating the relative dimension of elements in accordance with some embodiments of the disclosure. However, it should be appreciated that the disclosure is not limited to the presented relative dimensions in the Figures unless otherwise claimed.

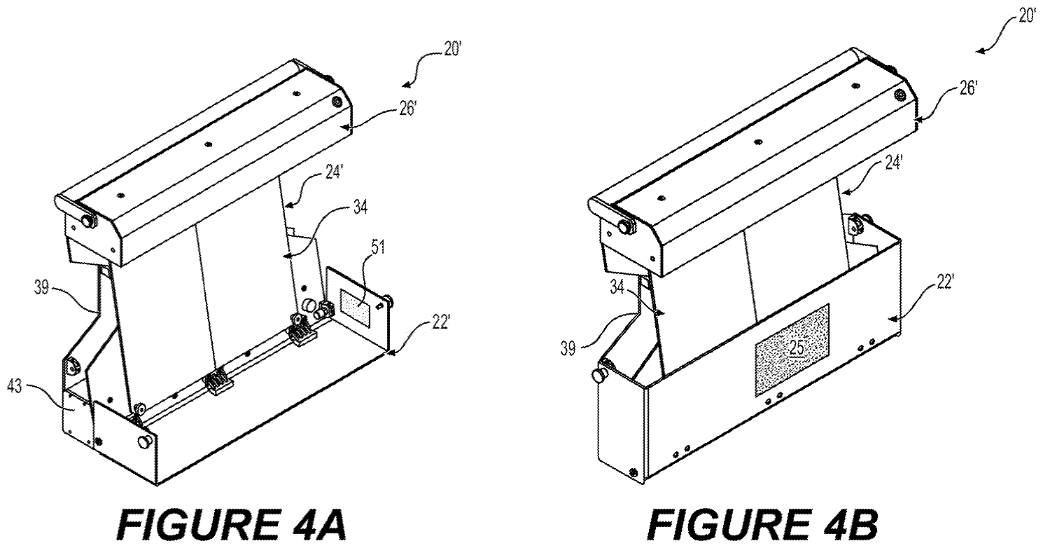

FIGS. 4A and 4B generally illustrated the manual inspection workstation assembly 20′ in accordance with a second embodiment of the disclosure. Unless otherwise specified, the manual inspection workstation 20′ includes all the same features as those described in reference to the other embodiments described herein.

The manual inspection workstation 20′ includes a base 22′ for positioning on a tabletop or other working surface and a body 24′ that extends vertically from the base 22′ to a hood 26′. The manual inspection workstation 20′ permits pivoting movement of the body 24′ with respect to the base 22′ between an upright position (FIG. 4A) and a stowed position (FIG. 4B). All or select portions of the manual inspection workstation assembly 20′ may include at least one coating 25 of protective material (FIG. 4B), The manual inspection workstation assembly 20′ differs from the other embodiments in that the bracket 36′ of the body 24′ includes a neck portion 39 that narrows towards the hood 26′. The neck portion 39 reduces the material requirements and also improves upon packaging of the manual inspection workstation assembly 20′ during travel as multiple manual inspection workstation assemblies 20′ can be secured together around their respective neck portions 39. The manual inspection workstation assembly 20′ further differs from the other embodiments in that the base 22′ is significantly smaller than the body 24′. A support beam 43 is located in the pocket 41 between the vertical plate 40, the horizontal plate 42, and the back plate 33. The support beam 43 adds support between the components outlining the pocket 41 and flintier provides weight to balance the manual inspection workstation assembly 20′ as the base 22′ is smaller.

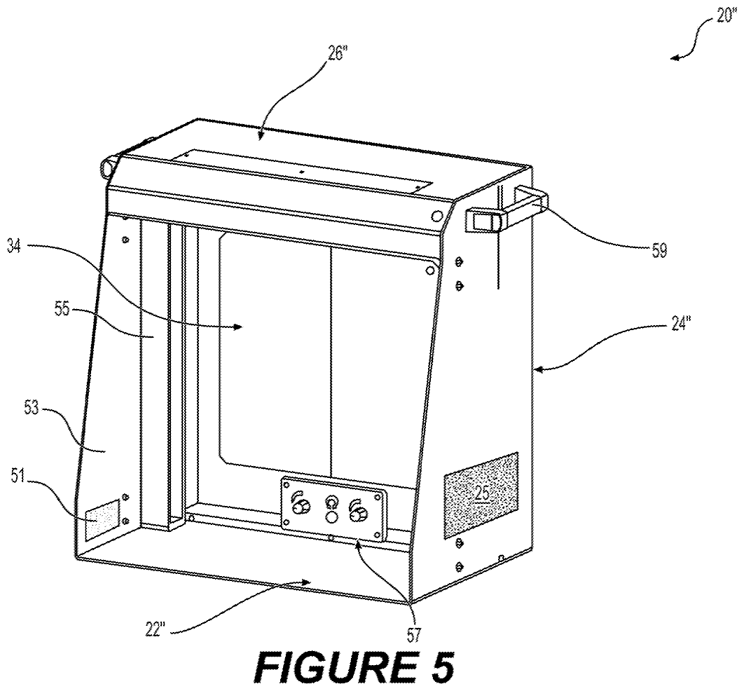

FIG. 5 generally illustrated the manual inspection workstation assembly 20″ in accordance with a third embodiment of the disclosure. Unless otherwise specified, the manual inspection workstation 20″ includes all the same features as those described in reference to the other embodiments described herein.

The manual inspection workstation 20″ includes a base 22″ for positioning on a tabletop or other working surface and a body 24″ that extends vertically from the base 22″ to a hood 26″. All or select portions of the manual inspection workstation assembly 20″ may include at least one coating 25 of protective material (FIG. 5). The manual inspection workstation assembly 20′ differs from the other embodiments in that tike base 22″ does not move between an upright position and a stowed position. In addition, the manual inspection workstation 20″ includes sidewalls 53 that extend from the base 22″ to the body 24″ and the hood 26″ for a relatively enclosed configuration that can block out a certain amount of illumination from sources other than the light source 70. The sidewalls 53 may taper from the base 22″ to the hood 26″. At least one portable light housing 55 may be attached to the sidewall 53 include at least one light source 70. Another light source 70 may be provided in the hood 26″. A user interface 57 may be located on the body 24′ and electrically connected to the one or more light sources 70 for controlling certain operations thereof that will be described in greater detail. In some embodiments, the user interface 57 may further include an audio connection for permitting an inspector to connect via headphones and a mic. The audio-in and audio-out may be controlled via a circuit, e.g., the light source circuit 200. Thus during use, instructions may be received by the inspector. The instructions may include details about the inspected element, preferred lighting settings, and additional data. Moreover, the audio-out may permit an inspector to ask questions for an instructor/inspection overseer. A pair of side handles 59 may be located on opposite ends of the hood 26″. The portable light housing 55 may be removable from the sidewall 53 such that it can be located at various locations on the manual inspection workstation assembly 20″. As such, the portable light housing 55 may be used in conjunction with the other embodiments described herein.

The light sources 70, the interior surface of the hood 26′, 26″, 26″, and the portable light housing 55 described in relation to the above embodiments may be oriented and configured provided wall washing or wall grazing lighting on the body 24, 24′, 24″ and, more particularly, the contrast plate 34. In some embodiments, wall washing or wall gazing lighting only is provided. In some embodiments, wall washing or wall grazing lighting is provided to the contrast plate 34 and uniform direct lighting is provided on the inspected element. In some embodiments, only uniform and direct lighting is provided. In some embodiments, a selection can be made between one or more of the wall washing or wall grazing lighting and uniform direct lighting depending on the inspected element or other protocols.

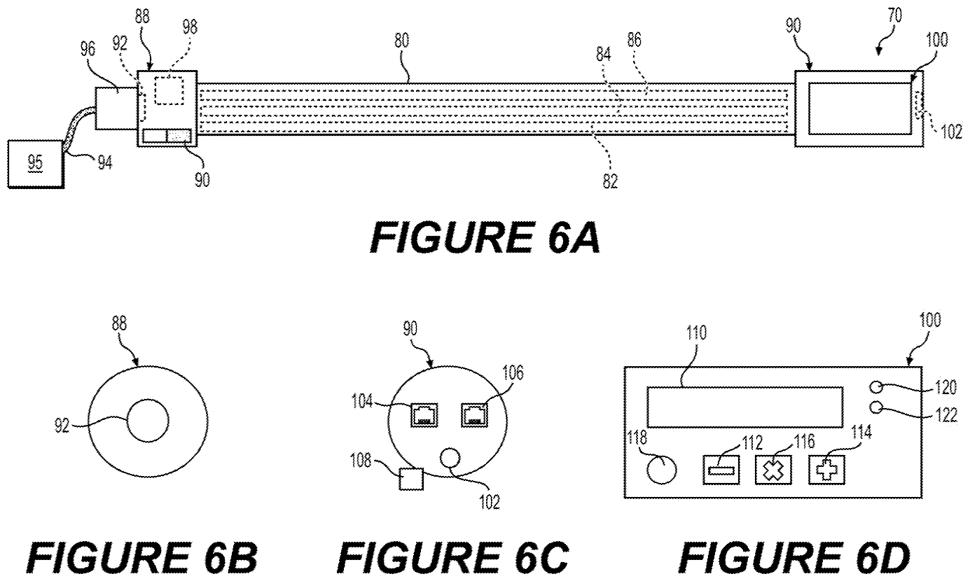

The light source 70 is presented in FIGS. 6A through 6D. The light source 70 is an intelligent light source. An intelligent light source may include automated or mechanical abilities beyond those of traditional stationary illumination Intelligent lights can produce extraordinarily complex effects and allow the operator of the control system, rather than the programmer, to choose and verify light settings. Intelligent lighting may also include automated lighting, moving lights or moving heads.

The light source 70 includes an elongated lens 80. The elongated lens SO may comprise transparent plastic, glass, or a combination thereof for permitting an unfiltered transmission of light therethrough. Contained within the elongated lens 80 is a source of red light 82, a source of green light 84, and a source of blue light 86. By individually controlling the intensity of the sources of light 82, 84, 86, numerous different colors of light can be generated. The elongated lens 80 extends between a first end and a second end, wherein the first end is connected to a power housing 88 and the second end is connected to an interface housing 90. The power housing 88, includes an on/off switch 90, for example, an AC power switch, and a power outlet port 92, for example, neutrik power connector (FIG. 6B). A cable 94 with a plug 96 corresponding to the power outlet port 92 can connect the power housing 88 to a source of power, such as a wall outlet, for example, via a connector having IEC 60320 breaking capacity. The AC power may include 90V to 246V. In the alternate or in addition to the cable 94, a rechargeable battery 98 may be located within the power housing 88. The cable 94 may alternatively be connected to a power supply component 95, such as the UNO POWER power supply, input: 1-phase, output: 24V DC/30W. Example light sources 70 include Smart LED lamps or tubes, cinema effect lights, lite mat, light panels, etc. For example, the light source 70 may include a Q-Rainbow RGBX Linear LED and other Cross Fade or Rainbow lights manufactured by Quasar Science, Titan Tubes Aster, Digital Sputnik Voyager, etc. In some embodiments, the light source 70 may include International Commission on Illumination lighting “CIE-lighting”, for example, D series CIE-lighting such as CIE-D50, CIE-D55, or CIE-D65. The D series CIE-lighting permits lighting profiles similar to natural lighting (e.g., between 330 nm and 700. More particularly, the CIE-D50 may operate at 5003K and the CIE-D65 may operate at 6504K.

The interface housing 90 is presented in FIG. 6A, 6C, and 6D and includes a user interface 100 and a power port 102, such as a DC power port for the rechargeable battery 98. The DC power my include 10V to 26V. FIG. 6C shows an end view of the interface housing 90, wherein the illustrated surface includes a communication system. The communication system may include DMX IN over Cat5 port 104 and a DMX OUT over Cat5 port 106 for pairing the light source 70 to a remote device such as another light source or a series of other light sources. For example, DMX512, which a standard for communication networks that are commonly used to control stage fighting and effects to automatically control the light intensity, color temperature, saturation, hue, and presets in the inspection hood, DMX512 employs EIA-485 differential signaling at its physical layer, in conjunction with a variable-size, packet-based communication protocol. The communication System may be unidirectional or bidirectional. RS-485, also known as TIA-485(-A), EIA-485, is may be a standard defining the electrical characteristics of drivers and receivers for use in the communications system. The communication system, such as digital communications networks implementing the standard can be used effectively over long distances and in electrically noisy environments. Multiple receivers may be connected to such a network in a linear, multi-drop bus. These characteristics make RS-485 useful in inspection applications requiring certain lighting protocols. Ports 104, 106 may be an RJ45 Jack 104, 106. A Cat5 to DMX adaptor 108 may further be provided. An enlarged view of the user interface 100 is presented in FIG. 6D The user interface 100 includes a screen 110, such as an OLED screen that displays various options to a user. A series of push buttons are provided wider the screen and includes a first adjustment button 112, a second adjustment button 114, and a select button 116. Switching between settings of the light source 70 may include highlighting selections on the screen 110 with one of the adjustment buttons 112, 114 and choosing the highlighted selection with the select button 116. Similarly, switching between settings may further include increasing intensity or other features by pressing the first adjustment button 112 and decreasing intensity or other features by pressing the second adjustment button 114. As will be described in greater detail below a linking button 118 may also be provided on the user interface 100 to allow wireless pairing with a remote device. The user interface 100 may further include a first notification light 120 and a second notification light 122. The first notification light 120 may be configured to illuminate when it is wirelessly paired to a remote device and the second notification light 122 may be configured to illuminate when the light is receiving data from the remote device. Lights 120, 122 may be further configured to blink in the event of a low battery charge or shine when the rechargeable battery 98 is charging. The user interface 100 may further be configured to provide usage data, for example, the last time a light source 70 was turned off or the total time the light source 70 was turned on. It should be appreciated the above features could also be present on an interface that is a touch screen. In some embodiments, the user interface 100 may be on a mobile computing, device, such as a smart phone, tablet, personal computer, etc., that is paired with the light source 70 in a wired or wireless configuration.

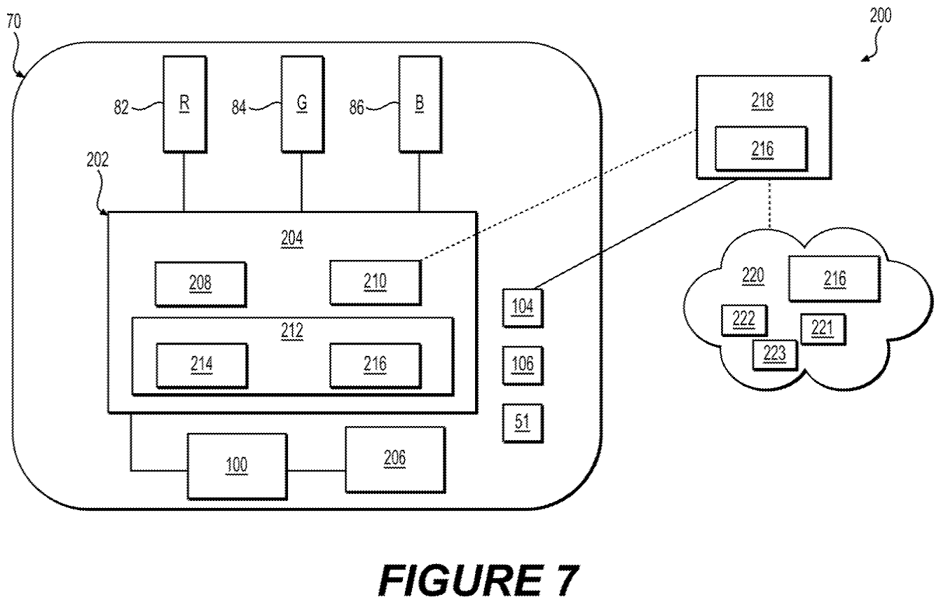

FIG. 7 is a schematic view of a light source circuit 200 including and an associated RGB circuit 202. The various elements provided therein allow for a specific implementation. Thus, one of ordinary skill in the art of electronics and circuits may substitute various components to achieve a similar functionality. The RGB circuit 202 ma include a microcontroller 204 that controls certain features and settings of the red light 82, the green light 84, and/or the blue light 86, such as regulating current from a power circuit 206 that may include one or both of the rechargeable battery 98 and the power outlet port 92. By adjusting the brightness of individual lights 82, 84, 86, the color output changes. The microcontroller 204 includes a microprocessor 208, a communications module 210, and a memory 212 having machine-readable non-transitory storage. In some embodiments, the memory 212 may include flash memory, semiconductor (solid state) memory or the like. In some embodiments, the memory 212 may include Random Access Memory (RAM), a Read-Only Memory (ROM), or a combination thereof. Programs and/or software 214 and light profile settings 216 are saved on the memory 212. The microprocessor 208 carries out instructions based on instructions stored in memory 212, for example, the software 214 may include instructions for changing colors at predetermined time intervals. Software 214 may be updated via the transmission of information between the communications module 210 and one or more remote computing devices 218 and a network 220 that includes software updates 222 and additional profile settings 216. For example, the remote computing device 218 may be a mobile device such as mobile phone, tablet, laptop, touchscreen technology, or wearable technology. Alternatively, turning on, color choice, brightness, and other additional settings of the RGB light circuit 202 may be controlled via the user interface 100 as previously described. Communications module 210 may include Bluetooth or other short or long range wireless linking technologies. The profile settings 216 may be stored in the local memory 212, in the remote computing device 218, or the network 220. Profile settings 216 may include recommended protocols For specific types of observations. For example, a user may select via the user interface 100 or the remote computing device 218 that the observable matter is a specific type of observable particulate matter in a parenteral (e.g., vial or syringe), using this information, a preconfigured lighting (profile setting 216) that is optimal for observing that particulate matter/solution/parenteral may be recommended and selected, initiating a specific light setting or sequence of settings protocol. For example, the light sequence may include a sequence of fluctuating settings, such as color, intensity, lux, etc. In instances wherein more than one light source 70 is located within the hood 26, the profile settings 216 may include instructions for changing only one of the light sources 70, changing all the light sources 70, or changing select light sources 70. For example, the instructions may include changing the light output at different rates or to different settings. Instead of relying on the communications module 210, the ports 104, 106 may also be used to form wired connections to the computing device 218. Similarly, in laboratory environments wherein many workstations are being used and several light sources 70 are working in conjunction and/or are wired together in a sequence or ring (daisy chained) via ports 104, 106, a recommended profile setting 216 selection from a singular remote computing device 218 may effectuate changing light settings in each of the light sources 70. In a similar fashion, when several light sources 70 are wired together in a sequence or ring, a selection of light properties on one user interface 100 (from a lead light source 70) may automatically be applied to ale other light sources 70. The photometric sensor 51 is in communication with the remote computing device 218 such that light readings can be saved and/or reviewed in real time. As such, the process validation that is required for numerous applications can be completed remotely via a computer validation process. The photometric sensor 51 may be in communication with the remote computing device 218 via the light source 70 through wired or wireless connection to the light source 70. Accordingly, data logged by the photometric sensor 51 may be saved within one or more of the memory 212 of the light source 70, locally within a memory of the photometric sensor 51, the remote computing device 218, and the server 220 as photometric reading data 221.

The light source circuit 200 includes intensity settings between 0% to 100% and color temperatures of 2000K to 6000K that may be changed in increments, for example. 100K increments, or less, or more. The settings may also include saturation settings between 0% to 100% and hue settings between 0° to 360°. The settings may further include color presets, e.g., red, yellow, orange, cyan. Other settings may further include lux, emittance, etc. These and other settings may be configurable via interface 100, a remote computing device 218, and may also be saved as profile settings 216 once established. The profile settings 216 may be saved initially on the memory 212 and then transferred to the remote computing device 218 and or the server 220.

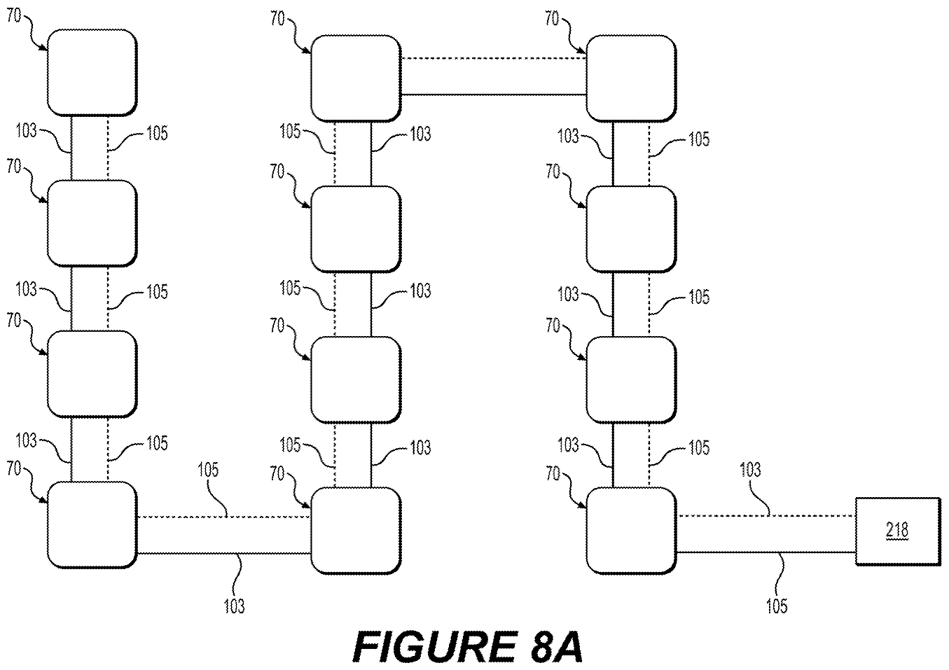

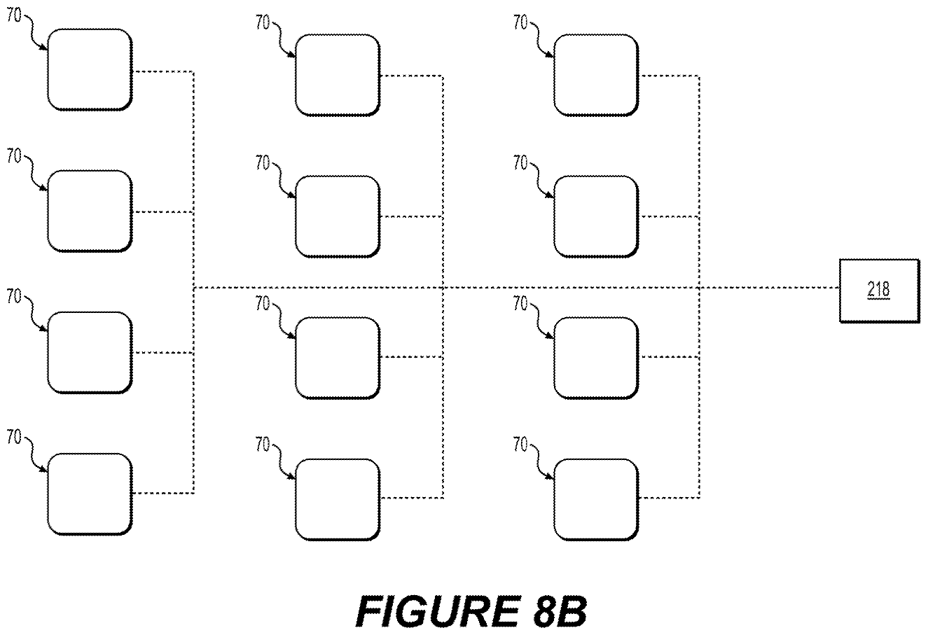

FIG. 8A illustrates a series of light sources 70, each including a light source circuit 200, connected to one another. Each of the light sources 70 are connected together in a sequence or a ring such that changing the setting of one of the light sources 70, changes the settings of each light source 70. Connection between light sources 70 may be a wired connection 103 (for example via an R145 Cat 5 cable) or a wireless connection 105 (via communications module 210) or both. As such, controlling settings on one light source 70 via the user interface 100, will effectuate similar setting changes in each of the other light sources 70. In such arrangements, one light source 70 may be designated “lead” via profile setting data 216 such it includes the only user interface that can be adjusted. Alternatively, the “lead” light source 70 may also be connected to the computing device 218 and the computing device 218 may be used for selecting settings as described above. In some embodiments, the software 210 and/or profile settings 216 may include varying the setting of adjacent light sources 70. For example, it may be beneficial to manually inspect an examined matter under more than one lighting condition. As such, in some embodiments, adjacent workstations have may different lighting conditions such as those previously described and an examined matter can be passed between light sources 70. It should be appreciated that each light source 70 illustrated in FIG. 8A may be located at its own workstation assembly 20.

FIG. 8B illustrates a series of light sources 70 in accordance with another configuration. The series of light sources 70 provided in FIG. 8B are not connected to each other but are each independently connected to the computing device 218, via the afore described wired or wireless connections. In this arrangement, the computing device can be used to change the settings of all light sources 70 (simultaneously) or select light sources 70. Utilizing the photometric sensor 51 readings from each of the light source 70, a validation process may be provided by comparing a setting of a light source 70 to the photometric readings. Because all the photometric reading data 221 is available remotely, the validation process can be localized or completed remotely and in a highly efficient mariner. For example, threshold data 223 may be saved corresponding to an aspect of the lighting, such as lux or any of the afore-described light settings. During the validation process, readings from the photometric sensor 51 may be compared with threshold data 223 via software, wherein readings outside of the threshold are indicated as not passing the validation process. Such a process oilers improvements over the prior art that previously resulted in subjective assessments or assessments based on or influenced by personal feelings, tastes, or opinions of an individual, auditor, or subject matter expert. It should be appreciated that each light source 70 illustrated in FIG. 8B may be located at its own workstation assembly 20, 20′, 20″.

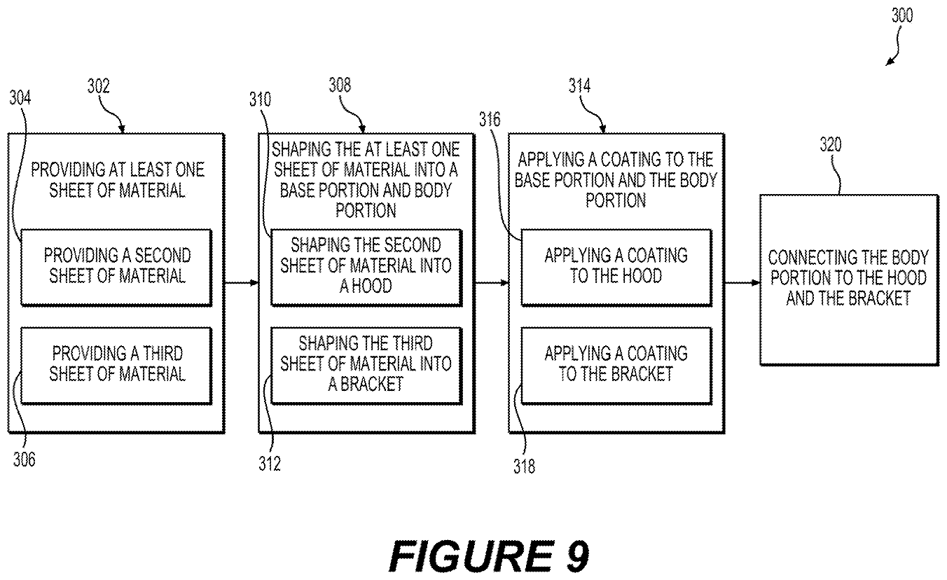

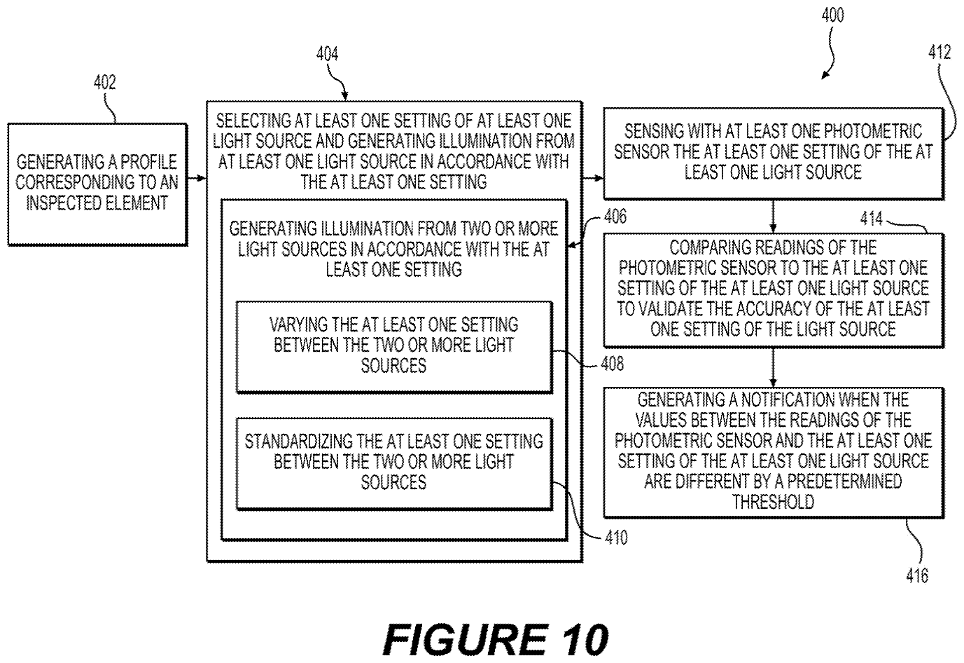

In accordance with the above, a method 300 of constructing the manual inspection workstation assembly is provided in FIG. 9. At 302, the method 300 includes providing at least one sheet of material. Step 302 may include providing 304 a second sheet of material and providing 306 a third sheet of material. The at least one sheet may comprise of aluminum material and more specifically aluminum material selected From series 5000 or series 6000. At 308, the at least one sheet of material is shaped into a base portion and a body portion. Step 308 may also include shaping 310 a hood and shaping a bracket 312. At 314, a coating is applied to the base portion and body portion. At 314, a coating may also be applied 316 to the hood and also applied 318 to the bracket. The coating may include one of a superhydrophobic coating, a cerakote coating, advanced polymer, ceramic, Endura coating, and other non-objectionable or FDA compliant coatings or films. Next, the base and body portions are attached 320 to the bracket and the hood.

In accordance with the method 300, in some embodiments, the manual inspection workstation assembly is constructed of a metal material and shaped via a process of stamping at 308. For example, the base, sidewalls, and backing plate can be constructed out of a singular sheet of material that is stamped or otherwise formed. Likewise, the hood (excluding handle) can be constructed out of a singular sheet of material that is stamped or otherwise formed. The vertical plate and the horizontal plate can also constructed out of a singular sheet of material that is stamped or otherwise formed. At 302, the sheets of material may be aluminum material and, in some arrangements, an aluminum alloy selected from the 5000 or 6000 series. Before or after the sheets are formed into corresponding components and before or after the components are connected to one another, the selected material undergoes a surface coating operation. At 314, the surface coating may be selected from a group of materials that are either compliant or non-objectionable by FDA regulations. For example, the surface coating may comprise one or more of the following: a superhydrophobic film coating, a cerakote coating, or a coating sold under the brand name Endura (for example Endura 334BLS). In some embodiments, the coating comprises a blend of non-stick polymers and high strength co-polymer reinforcements. The coating may also include levels of porosity and have a thickness of approximately 0.0008 inches, for example, 0.0006 to 0.0009 inches. In some embodiments, the coating can withstand prolonged temperatures of 500° F. and intermittent temperatures of 550° F. In some embodiments, at 302 and at 308, the manual inspection workstation assembly can be constructed of 3D printed continuous fibers such as Carbon Fiber, kevlar, HSHT fiberglass, fiberglass, Composite Carbon Fiber Nylon, other 3D Printed composites, Nylon Thermoplastic, etc. The manual inspection workstation assembly 20, 20′, 20″ can further be constructed out of 3D Printed Metals such as Interconel 625, D2 A2 And H13 Tool Steel, 17-4 PH 3D printed Stainless Steel, etc. Various components may be constructed out of different materials, for example, the hood may be 3D printed as discussed above while other portions are stamped from an aluminum metal material. When certain materials are used, for example an aluminum material, the manual inspection workstation is light and easy to move between locations.

Accordingly, systems and methods, such as those described herein, configured to provide a multiple light setting described herein, may be desirable. In some embodiments, the light source circuit 200 described herein may be configured to provide a series of setting to one, two, or more light sources 70. The settings may include one or more of a light intensity, a color temperature, a saturation, or a hue. In some embodiments, the setting may include one or more of wall washing, wall grazing, or uniform direct lighting, For example, one light source 70 may have a plurality of light settings and/or there may be multiple light sources 70 for providing one of the wall washing, wall grazing, or uniform direct lighting that can be selectively turned on and off In some embodiments, the selection of wall washing, wall grazing, or uniform direct lighting may be manual, e.g., via movement of the hood, an internal mirror (not shown), the contrast plate 34, or the portable light housing 55.

in accordance with these and other features, a method 400 of providing multiple setting to a manual workstation assembly is provided. At 402, the method includes generating a profile corresponding to an inspected element For example, certain inspected elements may benefit from a profile with specific settings such as at least one setting including one or more of a light intensity, a color temperature, a saturation, or a hue.

At 404, the method 400 includes selecting at least one setting of the light source and generating illumination from at least one light source in accordance with the at least one setting. For example, the at least one setting may include one or more of a light intensity, a color temperature, a saturation, or a hue.

At 406, the method 400 may further include generating illumination from or more light sources in accordance with the at least one setting. For example, the at least one setting may include one or more of a light Intensity, a color temperature, a saturation, or a hue

At 408, the method 400 may include varying the at least one setting between the two or more light sources.

At 410, the method 400 may include standardizing the at least one setting between the two or more light sources.

At 412, the method 400 may include sensing with at least one photometric sensor the at least one setting of the at least one light source.

At 414, the method 400 may include comparing readings of the photometric sensor to the at least one setting of the at least one light source to validate the accuracy of the at least one setting of the light source.

At 416, the method 400 may include generating a notification when the accuracy between the readings of the photometric sensor to the at least one setting of the at least one light source of different by a predetermined threshold.

It should be appreciated that the foregoing description of the embodiments has been provided for purposes of illustration. In other words, the subject disclosure it is not intended to be exhaustive or to limit the disclosure. Individual elements or features or a particular embodiment are generally not limited to that particular embodiment, but, where applicable, are interchangeable and can be used in a selected embodiment, even if not specifically shown or described. The same may also be varies in many ways. Such variations are not to be rewarded as a departure from the disclosure, and all such modifications are intended to be included within the scope of disclosure.

1. A manual inspection workstation comprising:
a base for placement of an inspected element;
a body pivotally connected to the base and movable between an upright position and a stowed position;
a hood located on the body opposite the base; at least one light source located within the hood; and
a light source circuit including:
a processor; and
a memory that includes instructions that, when executed by the processor, cause the processor to change at least one setting including one or more of a light intensity, a color temperature, a saturation, or a hue of the at least one light source; and
a photometric sensor located to receive illumination from the at least one light source, and wherein the instructions further cause the processor to compare readings of the photometric sensor to the at least one setting of the light source to validate an accuracy of the at least one setting of the at least one light source.

2. (canceled)

3. The manual inspection workstation of claim 1, wherein the processor is further caused to generate a profile setting based on a type of inspected element, the profile setting including one or more of the light intensity, the color temperature, the saturation, or the hue.

4. The manual inspection workstation of claim 1, wherein the at least one light source includes at least two light sources and each light source includes a port for connection to at least one other light source, wherein the processor is further caused to change the at least one setting equally on each light source of the at least two light sources.

5. The manual inspection workstation of claim 1, wherein the at least one light source includes at least two light sources and each light source includes a port for connection to at least one other light source, wherein the processor is further caused to change the at least one setting differently on each light source of the at least two light sources.

6. The manual inspection workstation of claim 1, wherein the at least one light source includes at least two light sources and each light source includes a port for connection to the other light source, wherein the processor is further caused to generate a profile setting for each of the at least two light sources communicated through the port based on a type of inspected element, the profile setting including one or more of the light intensity, the color temperature, the saturation, or the hue.

7. (canceled)

8. The manual inspection workstation of claim 1, wherein the processor is further caused to generate a notification when the accuracy between the readings of the photometric sensor to the at least one setting of the light source are different by a predetermined threshold.

9. The manual inspection workstation of claim 1, wherein the at least one light source includes a user interface for selecting the at least one setting.

10. The manual inspection workstation of claim 9, wherein the at least one light source includes at least two light sources and each light source includes a port for connection to the other light source, wherein the user interface on one of the light sources changes the at least one setting on both the light sources.

11. The manual inspection workstation of claim 1, wherein the at least one setting includes selecting a color temperature between 2000K and 6000K.

12. The manual inspection workstation of claim 1, wherein the base and the body comprise one of a series 5000 or a series 6000 Aluminum material.

13. The manual inspection workstation of claim 12, further including a coating on the base and the body, wherein the coating comprises at least one of a superhydrophobic coating, a cerakote coating, an advanced polymer, a ceramic, an Endura coating, or a FDA compliant coating.

14. A manual inspection workstation comprising:
a base for placement of an inspected element;
a body connected to the base;
at least one light source located on the body; and
a light source circuit comprising:
a processor;
a memory that includes instructions that, when executed by the processor, cause the processor to change at least one setting of the at least one light source, the at least one setting including one or more of a light intensity, a color temperature, a saturation, or a hue; and
a photometric sensor located to receive illumination from the at least one light source, and wherein the instructions further cause the processor to compare readings of the photometric sensor to the at least one setting of the light source to validate an accuracy of the at least one setting of the at least one light source.

15. The manual inspection workstation of claim 14, wherein the processor is further caused to generate a profile setting based on a type of inspected element, the profile setting including one or more of the light intensity, the color temperature, the saturation, or the hue.

16. The manual inspection workstation of claim 14, wherein the processor is further caused to generate a notification when the accuracy between the readings of the photometric sensor to the at least one setting of the light source are different by a predetermined threshold.

17. The manual inspection workstation of claim 14, wherein the at least one light source includes an International Commission on Illumination (CIE) series-D illuminant.

18. The manual inspection workstation of claim 14, wherein the CIE series-D CIE-lighting includes one of a CIE-D50, CIE-D55, or CIE-D65 illuminant.

19. The manual inspection workstation of claim 14, wherein the at least one setting includes a color temperature.

20. The manual inspection workstation of claim 14, wherein the at least one setting includes a saturation.

21. The manual inspection workstation of claim 14, wherein the light source circuit further includes a digital communication network interface configured communicate with at least one of another light source circuit or a remote computing device using DMX512 communications standard.
